(19) United States
(12) Patent Application Publication
(10) Pub. No.: US 2019/0082195 A1
(43) Pub. Date: Mar. 14, 2019

(54) Network Based Publication and Dynamic Distribution of Live Media Content

(71) Applicant: Anthony Teel, San Francisco, CA (US)

(72) Inventor: Anthony Teel, San Francisco, CA (US)

(73) Assignee: Roblox Corporation, San Mateo, CA (US)

(21) Appl. No.: 15/699,038

(22) Filed: Sep. 8, 2017

(51) Int. Cl. H04N 21/2187; H04N 21/262

(52) U.S. Cl. CPC H04N 21/2187; H04N 21/4782; H04N 21/26258

(57) ABSTRACT

A system includes a network-connected user platform having a processor executing software (SW) specific to an enterprise, a browser application executing on the processor of the user platform, the browser application including a real-time video protocol (RTVP) enabling two-way video streaming and communication with the enterprise-specific SW, and a network-connected server hosted by the enterprise, and providing content. The enterprise-specific SW connects on the network to the network-connected server providing content, and provides the content to the browser application in response to user-initiated events communicated to the enterprise-specific SW from the browser via the RTVP.

### BACKGROUND OF THE INVENTION

### 1. Field of the Invention

The present invention is in the field of media consumption of live online content, particularly video game content, and pertains particularly to methods and apparatus for enabling a Web visitor to view real time video, including game content, in a browser while visiting a Web page.

### 2. Discussion of the State of the Art

It is well-known to access and play video content through a page displayed in a web browser. YouTube is an example of a source, accessible by a web browser, with multiple channels with multiple video presentations that one might select to play the video. In many enterprise web sites, as well, there are embedded links to external video sources. For example, an educational web site might have educational videos stored at a separate site, such as Vimeo, and Vimeo provides links to be embedded in a page in the site, so a user may play a video, steamed from Vimeo, as though it is a part of the site. In this process, the user, invoking the link, is redirected to Vimeo, from which the video content is streamed.

A limitation of the video capabilities described above is that the videos are stored and the process is one-way. There is no functionality for real-time broadcasts and two-way interaction. Another example of video streaming initiated through a web browser, is in video games. In a system well-known to the present inventors, but not necessarily public domain, an enterprise provides a very large number of video games to players who register with the site. A page on the enterprise site provides indicia representing individual ones of the large number of video games that may be in progress with one or more players in the games. The indicia are associated with links to different games, and upon selection of a link, a player is redirected to a game server where that particular game is dynamically developing. The player making the selection may then enter and play the game that was selected.

It is desired by the inventors in this circumstance to enable players to view actual game content in real time, that being what is happening currently in a game, before determining whether to join the game, and to do so in the page in the browser where game indicia are presented. A challenge with that approach is that real time content must be captured and processed to publish that content onto a Web page that might promote the game.

The present inventors have developed a technology wherein real-time video may be experienced in a web browser without a plug-in, and with significantly higher quality that is possible in the prior art. The invention is enabled in several examples described in enabling detail below, with reference to diagrams and figures.

### BRIEF SUMMARY OF THE INVENTION

In one embodiment of the present invention, a system is provided, comprising a network-connected user platform having a processor executing software (SW) specific to an enterprise, a browser application executing on the processor of the user platform, the browser application including a real-time video protocol (RTVP) enabling two-way video streaming and communication with the enterprise-specific SW, and a network-connected server hosted by the enterprise, and providing content. The enterprise-specific SW connects on the network to the network-connected server providing content, and provides the content to the browser application in response to user-initiated events communicated to the enterprise-specific SW from the browser via the RTVP.

In one embodiment, the network-connected server stores and streams video games running in real time, and the user-initiated event is selection by a user of a game from a plurality of interactive indicia individually associated with games, wherein the selected game is displayed in a window associated with the interactive indicia selected. Also in one embodiment, the network-connected source of streaming video media is providing streaming video by use of one or more video cameras in real time. In one embodiment, the user is enabled to communicate by one or both of voice and text with a person having control over the cameras. And in one embodiment, after the window is selected, and the associated video game in progress is displayed, a user is enabled to enter into the video game.

In one embodiment of the system, the user is enabled to view the game in progress without entering the game. In one embodiment, selection that causes display of a video game in progress is a mouse-over, or activation of an interactive indicia. In one embodiment, the enterprise-specific software is downloaded from the network-connected server hosted by the enterprise. And in one embodiment the user is further provided with a video camera in the selected game, and may control viewpoint in the game.

In another aspect of the invention a method is provided, comprising connecting, with a browser application, including a real-time video protocol (RTVP), executing on a client platform, to an enterprise-hosted, network-connected server, determining that the enterprise site offers real-time content presentation, executing software (SW) specific to the enterprise, on the client platform, accessing real-time content from the enterprise-hosted, network-connected site, by the SW, and displaying the real-time content, via the RTVP, in a window in the browser application in response to navigation by the user in the browser application.

In one embodiment of the method, the network-connected server stores and streams video games running in real time as the real-time content, and the user-initiated event is selection by a user of a game from a plurality of interactive indicia individually associated with games, wherein the selected game is displayed in a window associated with the interactive indicia selected. Also in one embodiment, the network-connected source of streaming video media is providing streaming video by use of one or more video cameras in real time. Also in one embodiment, the user is enabled to communicate by one or both of voice and text with a person having control over the cameras. In one embodiment, after the window is selected, and the associated video game in progress is displayed, a user is enabled to enter into the video game. And in one embodiment, the user is enabled to view the game in progress without entering the game. Also in one embodiment selection that causes display of a video game in progress is a mouse-over, or activation of an interactive indicia. In one embodiment, the enterprise-specific software is downloaded from the network-connected server hosted by the enterprise. And in one embodiment, the user is further provided with a video camera in the selected game, and may control viewpoint in the game.

BRIEF DESCRIPTION OF THE SEVERAL VIEWS OF THE DRAWINGS

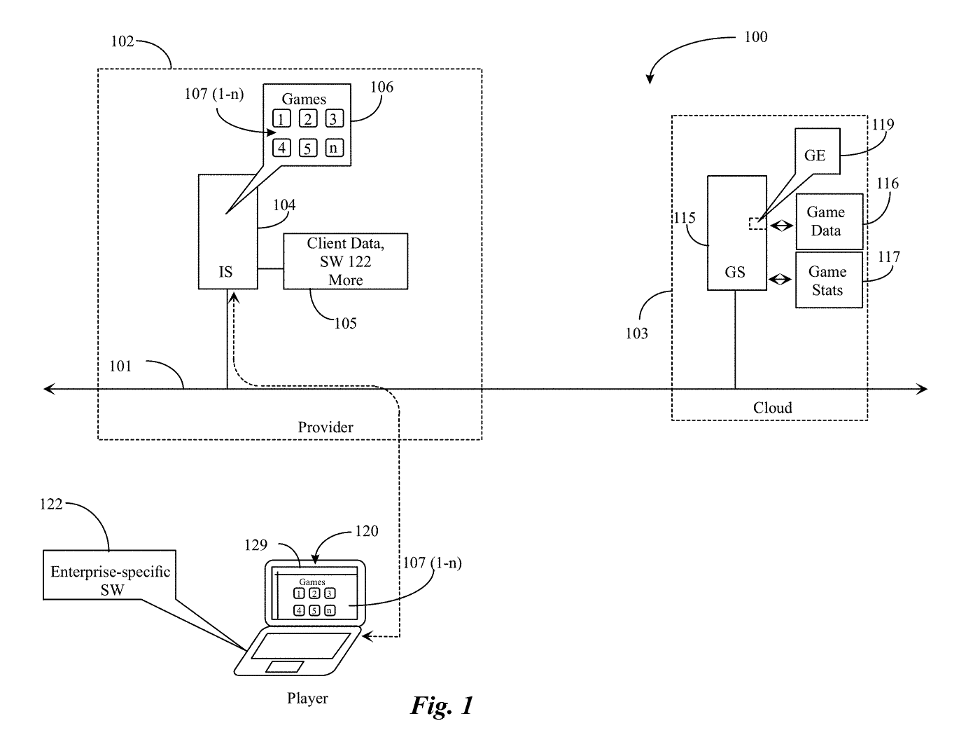

FIG. 1 is an architectural overview of a communications network supporting online gaming according to an embodiment of the present invention.

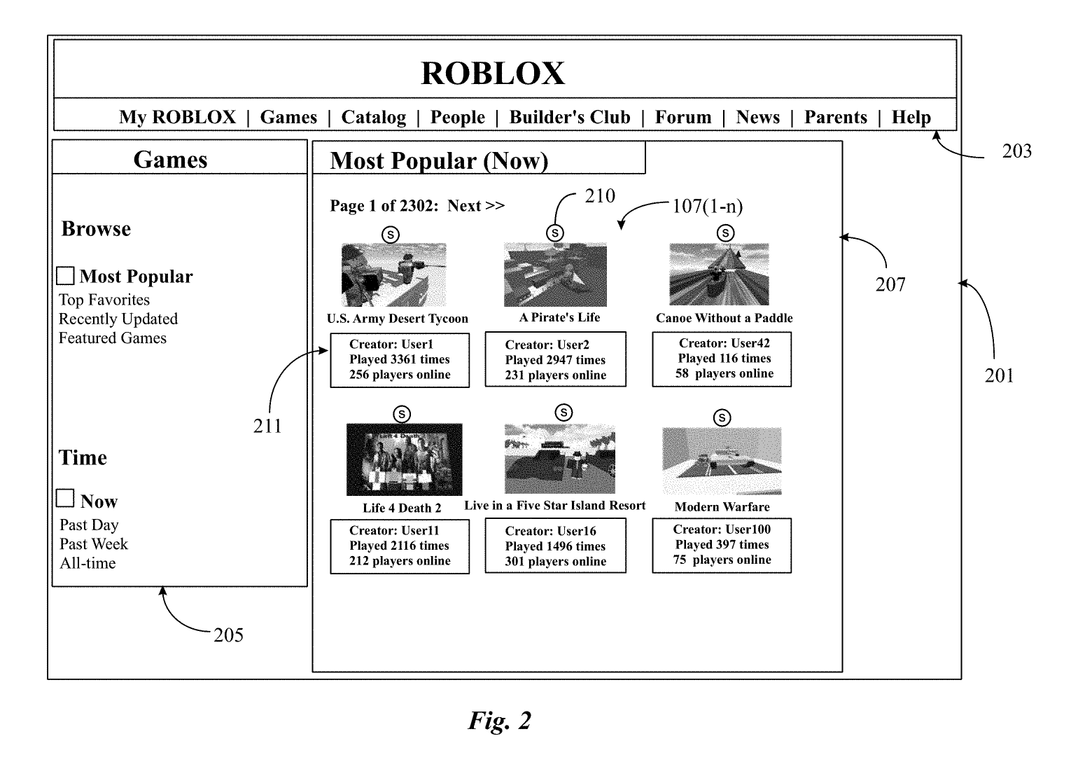

FIG. 2 is an example of a selection screen with iconic links in an embodiment of the present invention.

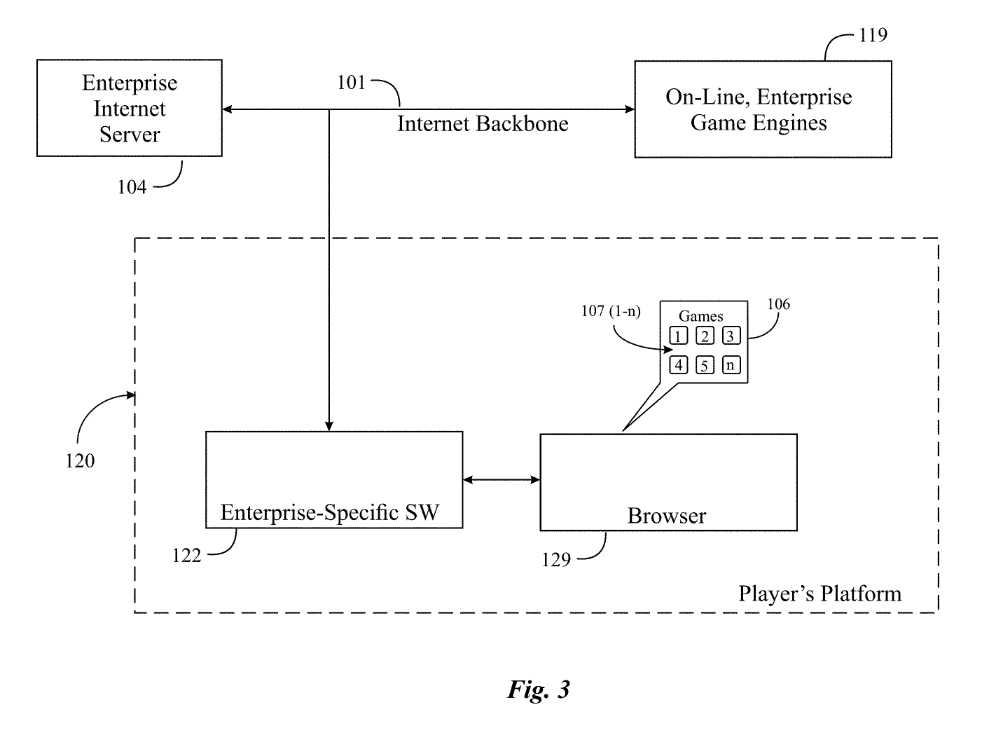

FIG. 3 is a diagram illustrating arrangement of elements in a system in an embodiment of the invention.

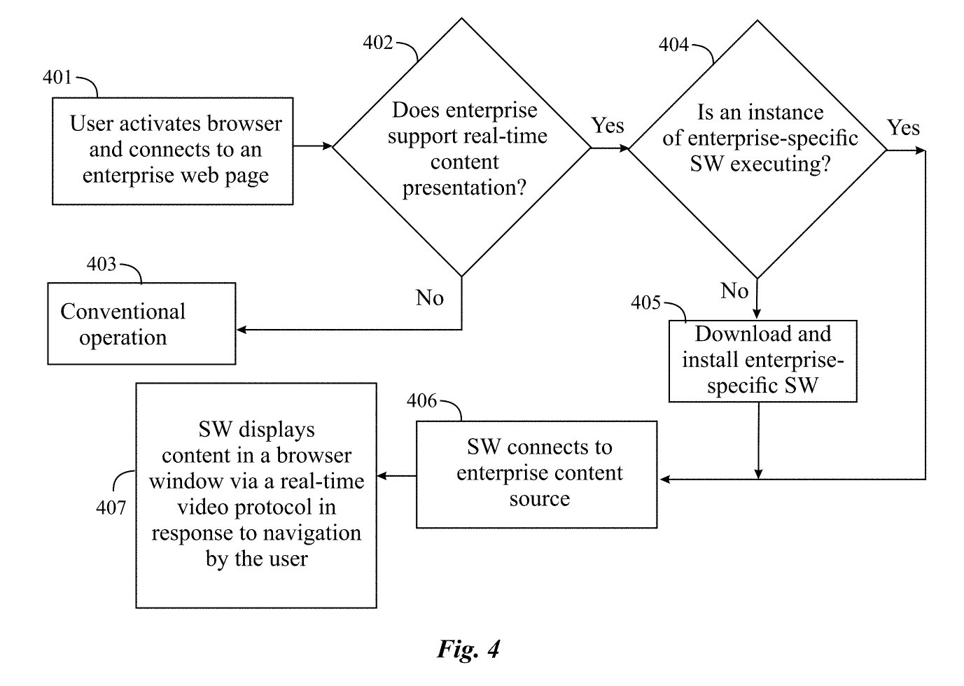

FIG. 4 is a flow diagram illustrating a method in an embodiment of the invention.

### DETAILED DESCRIPTION OF THE INVENTION

In various embodiments described in enabling detail herein, the inventor provides a unique system for publishing and dynamically distributing live, that is, real-time, media content. It is noted that the invention may be practiced in many different ways, and for a variety of purposes. As the inventors happen to be principles of an enterprise that manages user access and interaction with a very large number of video games from online game servers, through a web-browser interface, practice of the invention in this circumstance will be described in enabling detail as a first embodiment. Broadening description of other embodiments is described following the on-line gaming examples.

FIG. 1 is an architectural overview of a communications network 100 supporting online game interaction according to an embodiment of the present invention. Communications network 100 includes an Internet network depicted herein by an Internet network backbone 101. Backbone 101 represents all of the lines, equipment and access points that make up the Internet network as a whole, including connected sub-networks. Therefore, there are no geographic limitations on practice of the present invention. Network backbone 101 may be referred to hereinafter as Internet 101. Network backbone 101 may also represent a corporate wide area network (WAN), a municipal area network (MAN) or a publicly accessible local network segment, individually or in combination, without departing from the spirit and scope of the present invention.

Internet network 101 supports an Internet game-provider domain 102. Provider domain 102 may maintain an information server (IS) 104. Information server 104 may host information pages, such as Web sites with Web pages. Information server 104 may be a third-party hosted Web server for enabling access to a gaming Website 106, maintained by the provider. IS 104 may be wholly owned and operated by the gaming provider in this case without departing from the spirit and scope of the present invention. Website 106 may provide public access to online game and media interaction, and may include pages for registering new clients (players). In this example, Website 106 has a page displaying a plurality of online game links 107 (1-n) promoted to current players to browse, and to access and play from their network-connected gaming platforms or other computing appliances.

IS 104 connects to at least one data repository 105. Data repository 105 may store data regarding players, such as registration data, game play history, profile information, password information, and general account data for each player registered with the provider. Repository 105 may also store elements for forming website 106, and instances of enterprise-specific software that may be downloaded by players. Website 106 represents an access point for players to the provider site, such as a player operating a Laptop computer 120, depicted herein as having a network session, open with Website 106 over Internet 101.

A player using laptop 120, as an example of a platform for playing a game, may access Website 106 to register with the site (join as a member) to engage in various activities, including online consumption of media promoted through the site. In this example, the media for consumption may include online video games accessible by game links 107 (1-n). In one embodiment of the invention, Website 106 provides access to a unique, downloadable, enterprise-specific client software 122 that is important in practicing the present invention in various circumstances. SW 122 is described in further enabling detail below. SW 122 may be configured specifically for a type of device through which a player is accessing content, such as laptop 120, or another computing appliance such as a game station, an iPad, or a smart phone or tablet computer having computing hardware and software that may enable browser-based game access, display of content, and content interaction on the part of the player. Games represented as accessible through links 107 (1-n) on Website 106 may be served by one or more game servers (GS) such as a GS 115 having connection to network backbone 101. Game server 115 may be a server running in a cloud domain 103, or may, in some embodiments, be a part of domain 102. GS 115 may include one or more game engines 119 capable of executing and serving an online game or online media content selected from Website 106 by a player, such as the player operating laptop 120 through a web-browser application 129.

GS 115 may connect to at least one data repository 116 that may store game data for hosted games and media content. GS 115 may also connect to one or more data repositories, such as a data repository 117, that may store current and historical game statistics derived from player access and consumption of games, such as games accessible through links 107 (1-n), and attributed to hosted games and players that have accessed those games. GS 115 has connection to Internet backbone 101 in cloud domain 103.

Game links 107 (1-n) may typically show a game graphic that may include a game title. Other information may also be shown, such as a number of concurrent game instances running, if more than one. Other control options may be provided with each link, such as a button to enter or join to play the game.

FIG. 2 is an example of a selection screen 201 in an embodiment of the present invention. This screen, in this example, displays a panel 207 providing small windows 107(1-n), which, in one embodiment, present a picture or icon representing a game that is available for a visiting player to enter and play. These are equivalent to the links 107(1-n) described above with reference to FIG. 1. The links may be displayed as icons, or as pictures, which may be a single frame from a game represented. In this example six games are represented, the name of each game is presented just below the picture or icon, and additional information 211 may be displayed as well, including, in this example, the name or an ID number of the creator of the game, the number of times the game has been played, and the number of players that are currently playing in active instances of the game.

A command line 203 across the top of the page provides links and drop-down menus for a variety of destinations and functions available to a player visiting the selection page. A side panel 205 provides selection of modes for sorting a great variety of available games to be displayed here as available for a player to enter. Currently the top six most popular games are displayed as available, with the pics or icons linked to those games.

In one embodiment of the invention the inventor provides functionality, through web page 201, to provide streaming video in individual ones of windows 107(1-n), enabling a visiting player to actually watch a running instance of the game represented, rather than merely a name, a description, or a still picture, which may be a frame from a game represented.

FIG. 3 is a diagram representing a user's platform, platform 120 od FIG. 1 in this example, which may be a player's platform who visits page 201 to select a game to enter to play. The player's web-browser 109 is connected to website 106, which displays the selection page providing interactive windows 107(1-n) in the players display monitor.

Enterprise-specific SW 122 is shown as executing in the background on the player's platform, and is in two-way communication with browser 129 executing on the user's platform as well, though in the foreground. SW 122 is also shown connected through Internet backbone 101 to both Internet server 104 and to enterprise game engines 119, both also shown in FIG. 1.

To practice the invention an executing instance of an enterprise-specific SW 120 is necessary, and this SW may be downloaded previously from Enterprise IS 104, or may download to a player's platform at a time the player connects to IS 104. An important purpose of SW 122 is to provide unique functionality to the player in the player's display 106 by the browser 129. The unique functionality may differ depending on the enterprise, the enterprise web site, and purposes of the enterprise. In the current example, the inventor provides functionality for the display of interactive windows 107(1-n) to, upon a trigger event, display streaming video of a game in progress in the window of any one of the game specific windows 107(1-n) as seen in FIG. 2.

The unique functionality of an ability to display real-time video of a game in progress in this example is accomplished in the following manner: SW 122, specific to the gaming enterprise, provider 102, executes in the background on the player's platform, and is programmed to connect, in this example, to both the enterprise server 104 and to one or of game engines 119. SW 122 also is programmed to communicate two-way in real time with executing browser 129, such that navigation activities of a player viewing the browser display may be apparent to SW 122, as input to motivate activity by SW 122.

When a player connects to server 104 and views the selection page, windows 107(1-n) are displayed, and which windows is determined by selections in side panel 205 (see FIG. 2). In one embodiment, there may be a small interactive virtual button 210 adjacent to or as a part of a window 107, such that selection of this button sends info to SW 122 that the player has acted to begin streaming of real-time video of the game associated with the particular window for which the button is selected. This button is shown with an “s” for streaming in FIG. 2, but may be a bigger button with the word spelled out, and other language displayed.

Browser 129 in embodiments of the invention has functionality to communicate with SW 122 by a real-time video protocol (RTVP), one instance of which is known as WebRTC, which may be further referenced at URL https://en.wikipedia.org/wiki/WebRTC. State-of-the-art browsers are, at the time of this application, typically capable of this functionality. The inventor chooses to term this protocol RTVP because the skilled person will recognize that this functionality may be programmed in other ways than the specific protocol of WebRTC.

Button 210 is but one way that a player may select real-time streaming. The programming may also to react to a mouse-over of a window 107 to initiate real-time streaming. When SW 122 receives a signal that the player has selected a window, hence a game, for real-time streaming, SW 122 interacts with server 104 and game servers 119 to initiate real-time streaming of an instance of the game associated with the window 107 that was selected by the player for real-time streaming.

In one embodiment, cooperative SW executing on a processor in server 104 and SW 122 may select any running instance of the game associated with the selected window, and stream the real-time video to the window in the player's browser. In other embodiments, further requirements may be imposed on selection of a running instance of the game to stream. For example, in one embodiment there may be a requirement that only a game in which a player has entered and begun play within a pre-programmed short time frame may be chosen to stream. In another embodiment, the system may consult friends lists stored for the player, and determine whether there is a running instance in which a friend of the player is playing, and select that instance to stream to the window. If there are running instances in which more than one friend of the player is involved, programming may be to choose a game in which the greatest number of the player's friend are involved. Any one of or mixture of such criteria may be imposed in different embodiments to choose the running instance of the associated game that will be displayed for the player.

In one embodiment, once a player has selected to see a real-time stream of a game in progress, the system may provide an enhancement of the window, that is, a larger display, of the streaming video. The player who selects a game window, and is then able to view a real-time streaming of a game in progress, may choose to watch that game until the players in the game leave the game, or the game ends for any other reason. The player may also choose to enter the game by any selection technique that is enabled for that purpose, such as clicking on the widow, just as the player might do in the version of the selection page in which real-time streaming is not enabled.

In another embodiment of the invention the enterprise-specific SW may be programmed to provide a two-way communication with a player selecting a window associated with a specific game, such that the player may control a camera in the game, and may spectate in the game from player-selected viewpoints, without entering the game.

The embodiments described above provide unique functionality for an enterprise providing video games that are stored in game servers on-line. There are other applications for the present invention as well. For example, in one embodiment the client-specific SW 122 may be a video editor, or may have a video editor functionality, enabling a user to stream video in a browser window, and to edit that video. The user might start, stop, separate, carve out clips, and all of the functions that might be done with a video editor. Since the clip would be running in the background video editor, there is no need for the user to upload the full clip prior to editing.

In another embodiment, a real estate enterprise might provide an enterprise-specific SW to execute in the background on the user's platform, that enables a client, viewing a page in an enterprise website, to view real-time video, and to interact with the video as well. In this embodiment, the video may not be stored, but may be streamed by a live video camera, or a system of cameras, and there may be a equipment at the real-time production facility to enable the client to communicate directly with a principle in the streaming video. The client in this case may instruct the principles at the head-end to view a particular property, to pan around a room, to go to another room, and so on. Real-time negotiation may be accomplished.

FIG. 4 is a flow diagram illustrating a method in an embodiment of the invention. At step 401 a user activates a browser in a user platform, and connects to an on-line web page of a particular enterprise. At step 402 it is determined whether the enterprise site supports real-time content presentation. If not, operation continues conventionally at step 403. If the enterprise does support real-time presentation of content, at step 404 it is determined whether there is an instance of client-specific software executing in the client platform. If not, at step 405 an instance of that software may be downloaded, installed and activated.

If at step 404 it is determined that there is an executing instance of the client-specific software, at step 406 that software connects to an enterprise content source. Then at step 407 the client-specific software displays content from the content source in a window in a browser, via a real-time video protocol, in response to navigation by the user.

In one embodiment, as described above, the enterprise may be a video game provider, the content source may be game engines, and an active instance of a video game selected by a user in the browser display, may be displayed as real-time streaming video in a window in the web site. The client-specific software may provide additional functionality for selecting among multiple active instances of a game, according to pre-programmed criteria.

The skilled person will understand that there are a great many applications in such real-time promotion, sales, marketing and the like, that may be advantageously be accomplished using embodiment of the present invention.

It will be apparent to one with skill in the art that the RTVP content-streaming system of the invention may be provided using some or all of the described features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A system, comprising:
a network-connected user platform having a processor executing software (SW) specific to an enterprise;
a web browser executing on the processor of the user platform, the web browser including a real-time video protocol (RTVP) enabling two-way video streaming and communication with the enterprise-specific SW; and
a network-connected server hosted by the enterprise, and providing content;
wherein the enterprise-specific SW connects on the network to the network-connected server providing content, and provides the content to the web browser in response to user-initiated events communicated to the enterprise-specific SW from the web browser via the RTVP.

2. The system of claim 1 wherein the network-connected server stores and streams video games running in real time to the enterprise-specific software, and the user-initiated event is selection by a user of a game from a plurality of interactive indicia individually associated with games in a window of the web browser, wherein the selected game is displayed in a separate window associated with the interactive indicia selected.

3. The system of claim 1 wherein the network-connected source of streaming video media is providing streaming video by use of one or more video cameras in real time.

4. The system of claim 3 wherein the user is enabled to communicate by one or both of voice and text with a person having control over the cameras.

5. The system of claim 2 wherein, after the window is selected, and the associated video game in progress is displayed, a user is enabled to enter into the video game.

6. The system of claim 2 wherein the user is enabled to view the game in progress without entering the game.

7. The system of claim 4 wherein selection that causes display of a video game in progress is a mouse-over, or activation of an interactive indicia.

8. The system of claim 1 wherein the enterprise-specific software is downloaded from the network-connected server hosted by the enterprise.

9. The system of claim 6 wherein the user is further provided with a video camera in the selected game, and may control viewpoint in the game.

10. A method, comprising:
connecting, with a web browser, including a real-time video protocol (RTVP), executing on a client platform, to an enterprise-hosted, network-connected server;
determining that the enterprise site offers real-time content presentation;
executing software (SW) specific to the enterprise, on the client platform;
accessing real-time content from the enterprise-hosted, network-connected site, by the SW; and
displaying the real-time content, via the RTVP, in a window in the web browser in response to navigation by the user in the web browser.

11. The method of claim 10 wherein the network-connected server stores and streams video games running in real time as the real-time content, and the user-initiated event is selection by a user of a game from a plurality of interactive indicia individually associated with games, wherein the selected game is displayed in a window associated with the interactive indicia selected.

12. The method of claim 10 wherein the network-connected source of streaming video media is providing streaming video by use of one or more video cameras in real time.

13. The method of claim 12 wherein the user is enabled to communicate by one or both of voice and text with a person having control over the cameras.

14. The method of claim 11 wherein, after the window is selected, and the associated video game in progress is displayed, a user is enabled to enter into the video game.

15. The method of claim 11 wherein the user is enabled to view the game in progress without entering the game.

16. The method of claim 13 wherein selection that causes display of a video game in progress is a mouse-over, or activation of an interactive indicia.

17. The method of claim 10 wherein the enterprise-specific software is downloaded from the network-connected server hosted by the enterprise.

18. The method of claim 15 wherein the user is further provided with a video camera in the selected game, and may control viewpoint in the game.
